(19) United States
(12) Patent Application Publication
(10) Pub. No.: US 2022/0374497 A1
(43) Pub. Date: Nov. 24, 2022

(54) ANALYSIS APPARATUS, ANALYSIS METHOD, AND PROGRAM

(71) Applicant: NIPPON TELEGRAPH AND TELEPHONE CORPORATION, Tokyo (JP)

(72) Inventors: Hiroshi SAWADA, Tokyo (JP); Ko TAKEUCHI, Tokyo (JP); Tatsushi MATSUBAYASHI, Tokyo (JP); Takeshi KOSHIZUKA, Tokyo (JP)

(73) Assignee: NIPPON TELEGRAPH AND TELEPHONE CORPORATION, Tokyo (JP)

(21) Appl. No.: 17/618,444

(22) PCT Filed: Jun. 4, 2020
(86) PCT No.: PCT/JP2020/022163

§ 371 Date: Dec. 11, 2021

(30) Foreign Application Priority Data
Jun. 13, 2019 (JP) 2019-110230

(51) Int. Cl. G06F 17/16

(52) U.S. Cl. CPC G06F 17/16

(57) ABSTRACT

An analyzing device includes separating means that takes matrix data representing a non-negative matrix Y as input, and separate the matrix Y into a plurality of block matrices Yᵢ (i=1, . . . , I) configured of one column or two or more columns of the matrix Y, and updating means that executes repeated updating processing of a matrix Hᵢ and a matrix Uᵢ so that a product of the matrix Hᵢ and the matrix Uᵢ becomes close to the block matrices Yᵢ, in parallel, with regard to at least two or more of the block matrices Yᵢ. The updating means executes the repeated updating processing in parallel, on the basis of a graph structure given in advance in accordance with the matrix Y, so that the distance between predetermined matrices Hᵢ and Hⱼ (j≠i, j ∈ {1, . . . , I}) becomes closer.

### TECHNICAL FIELD

The present invention relates to an analyzing device, an analyzing method, and a program.

### BACKGROUND ART

There is known a technique called non-negative matrix factorization (NMF: Non-negative Matrix Factorization) as a technique for performing analysis of data expressed in non-negative values (e.g., text data, sound source data, customer data, etc.) such as compressing, visualization of latent characteristics, and so forth (e.g., see NPL 1). NMF is a technique in which data expressed in matrices is factorized into specified base numbers under a non-negative value constraint, to obtain low-rank approximation expressions. There are techniques other than NMF for obtaining low-rank expressions, such as principal component analysis and singular value decomposition, for example, but NMF handles only non-negative matrices, and the matrices following factorization are also limited to being non-negative matrices. Accordingly, NMF is capable of extracting latent characteristics that are more intuitive.

Now, in recent years, as the amount and types of data that can be handled has increased, there are more cases in which NMF is applied to large-scale matrices.

### CITATION LIST

### Non Patent Literature

[NPL 1] D. D. Lee and H. S. Seung, “Learning the parts of objects with nonnegative matrix factorization,” Nature, vol. 401, pp. 788-791, 1999.

### SUMMARY OF THE INVENTION

### Technical Problem

However, applying conventional NMF to large-scale matrices has required great amounts of calculation time in some cases.

An embodiment of the present invention has been made with the foregoing in view, and it is an object thereof to enhance the speed of calculation of non-negative matrix factorization.

### Means for Solving the Problem

In order to achieve the above object, an analyzing device according to an embodiment of the present invention includes separating means that takes matrix data representing a non-negative matrix Y as input, and separate the matrix Y into a plurality of block matrices Yᵢ (i=1, . . . , I) configured of one column or two or more columns of the matrix Y, and updating means that executes repeated updating processing of a matrix Hᵢ and a matrix Uᵢ so that a product of the matrix Hᵢ and the matrix Uᵢ becomes close to the block matrices Yᵢ, in parallel, with regard to at least two or more of the block matrices Yᵢ. The updating means executes the repeated updating processing in parallel, on the basis of a graph structure given in advance in accordance with the matrix Y, so that the distance between predetermined matrices Hᵢ and Hⱼ (j≠i, j ∈ {1, . . . , I}) becomes closer.

### Effects of the Invention

The speed of calculation of non-negative matrix factorization can be enhanced.

### BRIEF DESCRIPTION OF DRAWINGS

FIG. 1 is a diagram illustrating an example of a graph.

FIG. 2 is a diagram illustrating an example of a functional configuration of an analyzing device according to the present embodiment.

FIG. 3 is a diagram illustrating an example of a hardware configuration of the analyzing device according to the present embodiment.

FIG. 4 is a flowchart illustrating an example of the flow of non-negative matrix factorization according to the present embodiment.

FIG. 5 is a diagram illustrating an example of a graph having vertices corresponding to six districts.

FIG. 6A is a diagram illustrating an example of a basic matrix in a case of applying non-negative matrix factorization according to the present embodiment to Yₛₘₐₗₗ*(part 1).

FIG. 6B is a diagram illustrating an example of a basic matrix in a case of applying non-negative matrix factorization according to the present embodiment to Yₛₘₐₗₗ*(part 2).

FIG. 6C is a diagram illustrating an example of a basic matrix in a case of applying non-negative matrix factorization according to the present embodiment to Yₛₘₐₗₗ*(part 3).

FIG. 6D is a diagram illustrating an example of a basic matrix in a case of applying non-negative matrix factorization according to the present embodiment to Yₛₘₐₗₗ*(part 4).

FIG. 6E is a diagram illustrating an example of a basic matrix in a case of applying non-negative matrix factorization according to the present embodiment to Yₛₘₐₗₗ*(part 5).

FIG. 6F is a diagram illustrating an example of a basic matrix in a case of applying non-negative matrix factorization according to the present embodiment to Yₛₘₐₗₗ*(part 6).

FIG. 7A is a diagram illustrating an example of a basic matrix in a case of applying conventional non-negative matrix factorization to Yₛₘₐₗₗ*(part 1).

FIG. 7B is a diagram illustrating an example of a basic matrix in a case of applying conventional non-negative matrix factorization to Yₛₘₐₗₗ*(part 2).

FIG. 7C is a diagram illustrating an example of a basic matrix in a case of applying conventional non-negative matrix factorization to Yₛₘₐₗₗ*(part 3).

FIG. 7D is a diagram illustrating an example of a basic matrix in a case of applying conventional non-negative matrix factorization to Yₛₘₐₗₗ*(part 4).

FIG. 7E is a diagram illustrating an example of a basic matrix in a case of applying conventional non-negative matrix factorization to Yₛₘₐₗₗ*(part 5).

FIG. 7F is a diagram illustrating an example of a basic matrix in a case of applying conventional non-negative matrix factorization to Yₛₘₐₗₗ*(part 6).

FIG. 8 is a diagram illustrating an example of a basic matrix in a case of applying conventional non-negative matrix factorization to Yₛₘₐₗₗ.

FIG. 9 is a diagram illustrating an example of vertex coloring.

### DESCRIPTION OF EMBODIMENTS

An embodiment of the present invention (Hereinafter, also referred to as “present embodiment”.) will be described below in detail. In the present embodiment, a case where calculation of NMF is separated into a plurality of portions which have small dependencies (i.e., partial NMFs), and these plurality of partial NMFs are calculated in parallel, thereby speeding up the calculation of the original NMF, will be described.

<Conventional NMF>

First, conventional NMF will be described. In conventional NMF, in a case where a non-negative matrix

Y=[y₁y₂. . . Y_{M}]∈ [symbol] ≥0^{N×M} [Math. 1]

is given, setting a base number K yields, as matrices following factorization, a basic matrix

H∈ [symbol] ≥0^{N×K} [Math. 2]

and a weighting matrix

U∈ [symbol] ≥0^{K×M} [Math. 3]

Here, the problem of minimizing the distance function of HU and Y in which an original matrix Y approximates a product HU of a basic matrix H and a weighting matrix U is to be solved. For the distance function, the Frobenius norm, normalized KL divergence, the Itakura-Saito distance, or the like, for example, is used. In a case of using the Frobenius norm as the distance function, for example, the minimization problem of the distance function is formulated as in the following Expression (1).

$$\begin{matrix}[ Math . 4 ] & \\ minimize {‖ Y - \hat{Y} ‖}_{F}^{2} ( \hat{Y} = H U ) subject to H \geq 0 , U \geq 0 & ( 1 )\end{matrix}$$

Here, H≥0 and U≥0 each represents that each entry of the basic matrix H and the weighting matrix U are non-negative. Note that hereinafter, the product of the basic matrix H and the weighting matrix U, which is HU, will be written as “Y∧” as well.

There are several mathematical solutions proposed for the above-described minimization problem of the distance function, known examples of which include the multiplicative update rule (e.g., see Reference 1), ALS (Alternating Least Squares) (e.g., see Reference 2), and so forth.

[Reference 1] A. Cichocki, R. Zdunek, A.H. Phan, and S. Amari. Non-negative Matrix and Tensor Factorizations: Applications to Exploratory Multi-way Data Analysis and Blind Source Separation, Wiley, 2009.

[Reference 2] Cichocki, A., Zdunek R. and Amari, S.: Hierarchical ALS algorithms for nonnegative matrix and 3D tensor factorization, Proc. ICA (2007).

In a case in which the minimization problem shown in the above Expression (1) (i.e., the minimization problem of the Frobenius norm) is solved by the multiplicative update rule, the basic matrix H and the weighting matrix U is updated repetitively using Expression (2) below, upon first initializing the basic matrix H and the weighting matrix U. Such repetition is performed for a predetermined count of times set in advance, or until change before and after updating is no more than a certain value, for example.

$$\begin{matrix}[ Math . 5 ] & \\ {H}_{n , k} ← {H}_{n , k} \frac{{[ {YU}^{T} ]}_{n , k}}{{[ \hat{Y} {U}^{T} ]}_{n , k}} , {U}_{k , m} ← {U}_{k , m} \frac{{[ {H}^{T} Y ]}_{k , m}}{{[ {H}^{T} \hat{Y} ]}_{k , m}} & ( 2 )\end{matrix}$$

Here, H_{n,k} is the (n, k) entry of the basic matrix H, and U_{k,m} is the (k, m) entry of the weighting matrix U.

Thus, matrices H and U are obtained, where the product of the basic matrix H and the weighting matrix U approximate the original matrix Y (that is to say, the non-negative matrix Y is factored into matrix H and matrix U).

### NMF According to Present Embodiment

Next, the NMF according to the present embodiment will be described. In a case where the NMF according to the present embodiment is given the non-negative matrix Y, this matrix Y is separated into columns, and a plurality of block matrices Y₁, Y₂, . . . , Y_{I} is obtained. Thereinafter, NMF is applied to each of the plurality of block matrices Y₁, Y₂, . . . , Y₁, which are factored into basic matrices H₁, H₂, . . . , H₁ and weighting matrices U₁, U₂, . . . , U_{I}. The NMF calculations on each of these block matrices Y₁, Y₂, . . . , Y_{I} are not interdependent, thus are executable in parallel. However, there are cases where applying conventional NMF on each of the block matrices Y₁, Y₂, . . . , Y_{I} individually without change yields a plurality of different basic matrices, and each of the block matrices are expressed in different feature spaces. Accordingly, regarding the NMF according to the present embodiment, the distances of predetermined basic matrices Hᵢ and Hⱼ are made to be small at the same time as when applying the NMF to each of the block matrices Y₁, Y₂, . . . , Y_{I}. Thus, in the NMF according to the present embodiment, speed of calculation can be enhanced, as well as results equivalent to conventional NMF being obtainable. Note that hereinafter, Y*, H*and U*may be used to write Y*={Y₁, Y₂, . . . , Y_{I}}, H*={H₁, H₂, . . . , H_{I}}, and U*={U₁, U₂, . . . , U₁}, as well.

Describing the NMF according to the present embodiment in further detail, in a case where a non-negative matrix Y is given, this matrix Y is factored into columns as shown below, and then factored into a plurality of block matrices Y*={Y₁, Y₂, . . . , Y_{I}} (Yᵢ≥0).

$$( \begin{matrix}\begin{matrix} \\ {Y}_{1}\end{matrix} \\ \end{matrix} \vert \begin{matrix}\begin{matrix} \\ {Y}_{2}\end{matrix} \\ \end{matrix} \vert … \vert \begin{matrix}\begin{matrix} \\ {Y}_{I}\end{matrix} \\ \end{matrix} ) \qquad [ Math . 6 ]$$

That is to say, each block matrix Yᵢ is a matrix configured of one column or two or more continuous columns, of matrix Y.

Also, in the NMF according to the present embodiment, in a case where Hᵢ and Hⱼ, out of H*(and U*) which are obtained as an output, are to be made similar basic matrices (that is to say, in a case where the distance of Hᵢ and Hⱼ is to be made small), an undirected graph G (V={1, 2, . . . , I}, E) is given, where edge (i, j) ∈ E. Furthermore, an adjacency matrix of the graph G is A (G)=(aᵢⱼ). V is a set of vertices of the graph G, and E is a set of the edges of the graph G.

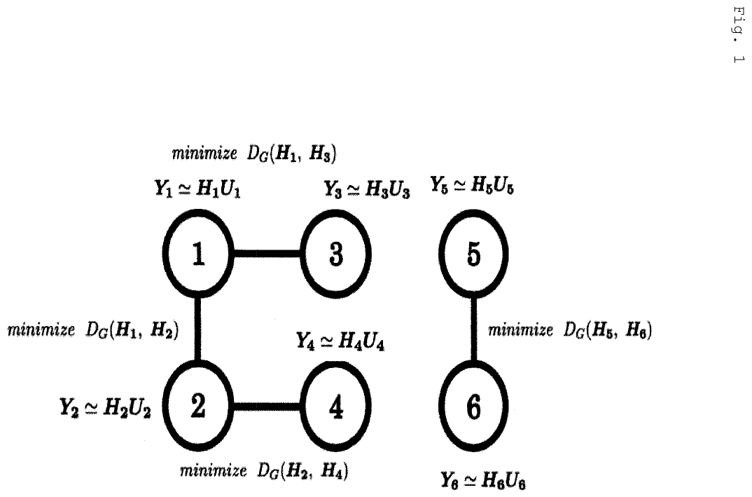

An example of graph G in a case where I=6 is illustrated in FIG. 1. In the graph G illustrated in FIG. 1, each of node 1 and node 2, node 1 and node 3, node 2 and node 4, and node 5 and node 6, are connected by edges. Thus, in a case where H₁ and H₂, H₁ and H₃, H₂ and H₄, and H₅ and H₆ are each a basic matrix in the same way, the graph G illustrated in FIG. 1 is given. Note that which basic matrices will be similar to each other (that is to say, which pair of basic matrices will be connected by edges in the graph G) will be appropriately set according to the characteristics and so forth of the data analyzed using NMF.

Here, in the NMF in the present embodiment, basic matrix H*and weighting matrix U*are obtained by minimizing an object function illustrated in Expression (3) below.

$$\begin{matrix}[ Math . 7 ] & \\ minimize {\sum }_{i}^{I} \{ {D}_{R} ( {Y}_{i} , {H}_{i} {U}_{i} ) + \frac{α}{2 \vert {S}_{i} \vert} {\sum }_{( i , j ) ϵ E} {D}_{G} ( {H}_{i} , {H}_{j} ) \} & ( 3 )\end{matrix}$$

$$where , {S}_{i} = \{ j \vert ( i , j ) ∈ E \}$$

$$subject to {H}_{i} , {U}_{i} \geq 0 ( ∀ i ∈ \{ 1 , 2 , … , I \} ) ,$$

Here, D_{R} and D_{G} are distance functions, and a is a hyperparameter. The first term of the object function shown in the above Expression (3) (i.e., D_{R} (Yᵢ, Hᵢ Uᵢ)) is a term representing reconstruction error, and the second term (i.e., the term that includes D_{G} (Hᵢ, Hⱼ)) is a term representing the distance between predetermined basic matrices. By introducing the second term into the object function shown in the above Expression (3), predetermined basic matrices Hᵢ and Hⱼ (i.e., between basic matrices that correspond to the node that are connected to each other by an edge in a given graph G) can become matrices that are similar.

For example, in a case where the graph G illustrated in FIG. 1 is given, and D_{R} (Y₁, H₁U₁)+(α/2) {D_{G} (H₁, H₂)+D_{G} (H₁, H₃)}, where i=1, is calculated. Thus, due to the presence of the second term, the distances between H₁ and H₂, and H₁ and H₃ can be made smaller in this case.

(Case Where Frobenius Norm is Used as Distance Functions D_{R} and D_{G})

In a case where the Frobenius norm is used as both distance functions D_{R} and D_{G}, the basic matrix H₁ and the weighting matrix Uᵢ that minimize the object function shown in the above Expression (3) can be found by the multiplicative update rule. That is to say, the basic matrix Hᵢ and the weighting matrix Uᵢ that minimize the object function shown in the above Expression (3) can be found, by updating the basic matrix H₁ and the weighting matrix Uᵢ by repetitively using the Expression (4) below.

$$\begin{matrix}[ Math . 8 ] & \\ {H}_{i , n , k} ← {H}_{i , n , k} \frac{{[ {Y}_{i} {U}_{i}^{T} ]}_{n , k} + \frac{α}{\vert {S}_{i} \vert} {\sum }_{( i , j ) ∈ E} {H}_{j , n , k}}{{[ {\hat{Y}}_{i} {U}_{i}^{T} ]}_{n , k} + \frac{α}{\vert {S}_{i} \vert} {\sum }_{( i , j ) ∈ E} {H}_{j , n , k}} & ( 4 )\end{matrix}$$

$${U}_{i , k , m} ← {U}_{i , k , m} \frac{{[ {H}_{i}^{T} {Y}_{i} ]}_{k , m}}{{[ {H}_{i}^{T} {\hat{Y}}_{i} ]}_{k , m}} ( where , {Y}_{i} = {H}_{i} {U}_{i} )$$

Here, H_{i,n,k} is the (n, k) entry of the basic matrix Hᵢ, and U_{i,k,m} is the (k, m) entry of the weighting matrix Uᵢ.

(Case where Normalized KL Divergence is Used as Distance Functions D_{R} and D_{G})

In a case in which the distance function D_{G} is the normalized KL divergence, the object function shown in the above Expression (3) cannot be minimized by the multiplicative update rule. This is due to the update formula of the basic matrix Hᵢ no longer being an update formula maintaining non-negativity. Accordingly, in the case in which the distance function D_{G} is the normalized KL divergence, D_{G} is written as D_{KL}, and an object function shown below in Expression (5) is used instead of the object function shown in the above Expression (3).

$$\begin{matrix}[ Math . 9 ] & \\ minimize {\sum }_{i}^{I} \{ {D}_{R} ( {Y}_{i} , {H}_{i} {U}_{i} ) + \frac{α}{\vert {S}_{i} \vert} {\sum }_{( i , j ) ∈ E} {D}_{KL} ( {H}_{i} + I , {H}_{j} + I ) \} \\ where \\ {S}_{i} = \{ j \vert ( i , j ) ∈ E \} , \\ I : matrix where all entries are 1 \\ subject to {H}_{i} , {U}_{i} \geq 0 ( ∀ i ∈ \{ 1 , 2 , … , I \} ) . & ( 5 )\end{matrix}$$

Here, A and B are each defined as below.

$$A = {[ ( {Y}_{i} ∅ {\hat{Y}}_{i} ) {U}_{i}^{T} ]}_{n , k} + \frac{α}{\vert {S}_{i} \vert} {\sum }_{( i , j ) ∈ E} log ( {H}_{j , n , k} + 1 ) + \frac{( {H}_{j , n , k} + 1 )}{( {H}_{i , n , k} + 1 )} B = {\sum }_{m} {[ {U}_{i} ]}_{k , m} + \frac{α}{\vert {S}_{i} \vert} {\sum }_{( i , j ) ∈ E} ( log ( {H}_{i , n , k} + 1 ) + 1 ) \qquad [ Math . 10 ]$$

Also, the basic matrix Hᵢ and the weighting matrix Uᵢ are updated repetitively using Expression (6) below. Thus, the basic matrix Hᵢ and the weighting matrix Uᵢ in which the object function shown in the above Expression (5) is minimized can be found.

$$\begin{matrix}[ Math . 11 ] & \\ {H}_{i , n , k} ← {H}_{i , n , k} \frac{A}{B} \\ {U}_{i , k , m} ← \frac{{[ {H}_{i}^{T} ( {Y}_{i} ∅ {\hat{Y}}_{i} ) ]}_{k , m}}{{\sum }_{n} {[ {H}_{i} ]}_{n , k}} \\ The ∅ here represents division for each element . & ( 6 )\end{matrix}$$

Note that the “+1” in the second term “log (H_{j,n,i}+1)” of the definition regarding the above A is a constant term that prevents the log from becoming a negative value. Therefore, it is not necessary for this constant term to be “+1”, and an arbitrary c (≥0) where log (H_{j,n,l}+c) becomes non-negative can be this constant term. Likewise, with respect to the “+1” of “log (H_{j,n,l}+1)” included in the second term regarding the definition of the above B, the arbitrary c (≥0) can be used as a constant term instead of “+1” where log (H_{j,n,l}+c) becomes non-negative.

In the above, the case where the distance functions D_{R} and Dc are both the Frobenius norm, and the case where the distance functions D_{R} and Dc are both the normalized KL divergence are described. However, different distance functions may be used for each of the distance functions D_{R} and D_{G}. Accordingly, the update formula of H_{i,n,k} can be organized as in Expression (7) below.

$$\begin{matrix}[ Math . 12 ] & \\ {H}_{i , n , k} ← {H}_{i , n , k} \frac{NL + \frac{α}{\vert {S}_{i} \vert} {\sum }_{( i , j ) ∈ E} NR}{DL + \frac{α}{\vert {S}_{i} \vert} {\sum }_{( i , j ) ∈ E} DR} & ( 7 )\end{matrix}$$

Here, in the case where D_{R} is the Frobenius norm,

NL=[YᵢUᵢ^{T}]_{n,k},DL=[ŶᵢUᵢ^{T}]_{n,k} [Math. 13]

holds, and in the case where D_{R} is the normalized KL divergence,

$$N L = {[ ( {Y}_{i} ∅ {\hat{Y}}_{i} ) {U}_{i}^{T} ]}_{n , k} , DL = {\sum }_{m} {[ {U}_{i} ]}_{k , m} \qquad [ Math . 14 ]$$

holds. Also, in the case where Dc is the Frobenius norm,

NR=H_{j,n,k},DR=H_{i,n,k} [Math. 15]

holds, and in the case where Dc is a normalized KL divergence,

$$NR = log ( {H}_{j , n , k} + 1 ) + \frac{( {H}_{j , n , k} + 1 )}{( {H}_{i , n , k} + 1 )} \\ DR = log ( {H}_{i , n , k} + 1 ) + 1 \qquad [ Math . 16 ]$$

holds. Note that in the case where Dc is the normalized KL divergence, an arbitrary c (≥0) can be used as the “+1” in the first term of NR “log (H_{j,n,l}+1)” in which log (H_{j,n,l}+c) becomes non-negative, in the same way as the above definitions of A and B. Similarly, in the case where D_{G} is the normalized KL divergence, an arbitrary c (≥0) can be used as the “+1” in the first term of DR “log(H_{j,n,l}+c)” in which log (H_{j,n,l}+1) becomes non-negative, in the same way as with the above definitions of A and B.

<Functional Configuration>

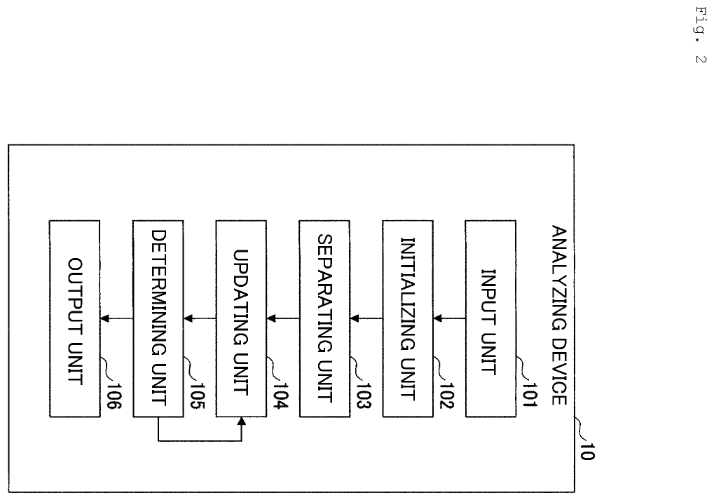

Next, the functional configuration of an analyzing device 10 that executes NMF in the above-described present embodiment will be described with reference to FIG. 2. FIG. 2 is a diagram illustrating an example of a functional configuration of the analyzing device 10 according to the present embodiment.

As illustrated in FIG. 2, the analyzing device 10 according to the present embodiment has an input unit 101, an initializing unit 102, a separating unit 103, an updating unit 104, a determining unit 105, and an output unit 106, as functional units.

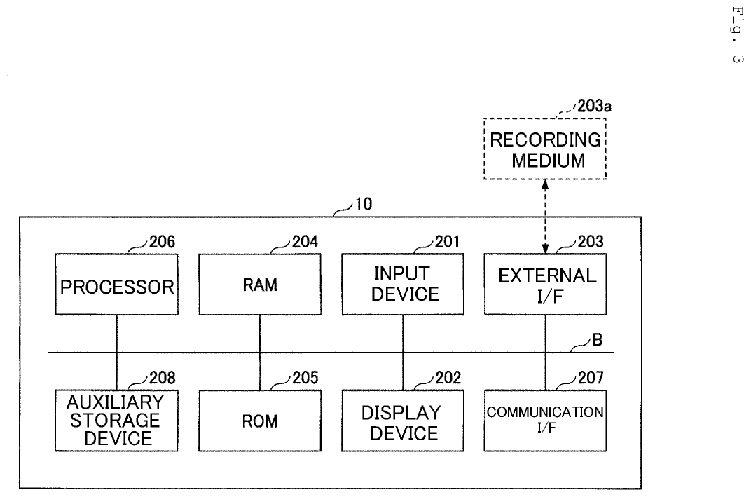

The input unit 101 inputs data analyzed using the NMF of the present embodiment (data expressed in non-negative matrices) to the separating unit 103. Note that the input unit 101 can input data from any input source. For example, the input unit 101 may input the data stored in an auxiliary storage device 208 as illustrated in FIG. 3, may input (receive) data from a predetermined server device or the like via a communication network, or may input data recorded in a recording medium 203a illustrated in FIG. 3.

The initializing unit 102 sets an initial value of the basic matrix Hᵢ and the weighting matrix Wᵢ serving as the results of the NMF according to the present embodiment. The initializing unit 102 may, for example, set the value sampled from a uniform distribution as the initial value of each entry of both the basic matrix Hᵢ and the weighting matrix Wᵢ.

The separating unit 103 separates the matrix Y expressing the data input by the input unit 101 into a plurality of block matrices Y₁, Y₂, . . . , Y_{I}. Also, the separating unit 103 allocates each of the data expressed in this plurality of block matrices Y₁, Y₂, . . . , Y₁ to a memory space of a child process. NMFs for each of the block matrices Yᵢ are calculated in parallel within these child processes.

Note that a child process is a process that is called up from a parent process, and the child processes are called up for each of the block matrices Yᵢ respectively. In the parent process, for example, data input by the input unit 101, initialization by the initializing unit 102, output by the later-described output unit 106, and so forth, are performed. Meanwhile, in the child processes, updating by the later-described updating unit 104, determination by the later-described determining unit 105, and so forth, are performed.

The updating unit 104 updates each of the entry of the basic matrix Hᵢ and the weighting matrix Uᵢ according to the above Expression (4) or Expression (6), on the basis of the data expressing the block matrix Yᵢ and a graph structure of the graph G that is given. Note that in the present embodiment, the graph G corresponding to the characteristics and so forth of the data analyzed using the NMF (i.e., the data input by the input unit 101) is given to the analyzing device 10 in advance.

The determining unit 105 determines whether a predetermined end condition is satisfied or not. In a case where the predetermined end condition is not satisfied, the updating unit 104 performs the update again. Conversely, in a case where the predetermined end condition is satisfied, the later-described output unit 106 performs output. Accordingly, each entry of the basic matrix Hᵢ and the weighting matrix Uᵢ are repetitively updated by the updating unit 104 until the predetermined end condition is satisfied.

Here, examples of the predetermined end condition include one of the following (end condition 1) through (end condition 3), or the like.

(End Condition 1)

The count of repetition of updates by the updating unit 104 reaches a predetermined count.

(End Condition 2)

The absolute value of the difference of the two values described below becomes lower than a predetermined threshold value. The first value is the value of the object function calculated on the basis of the block matrix Yᵢ, the basic matrix Hᵢ, and the weighting matrix Uᵢ, before the update by the by the updating unit 104 at the immediately previous count of repetition. The second value is the value of the object function calculated on the basis of the block matrix Yᵢ, the basic matrix Hᵢ, and the weighting matrix Uᵢ, after the update by the updating unit 104 at the immediately previous count of repetition. That is to say, the decrease of the value of the object function, before and after the update of the basic matrix Hᵢ and the weighting matrix Uᵢ, is no more than a predetermined threshold value.

(End Condition 3)

The value by which each entry in the above Expression (4) or Expression (6) is multiplied (that is to say, the value of the fractional portion by which H_{i,n,k} and Uᵢ,n,k are multiplied) approaches 1, at the immediately previous count of repetition. That is to say, the absolute value of the difference of this value of the fractional portion and 1 (amount of update) is no more than a predetermined threshold value.

In a case where the determining unit 105 determines that the predetermined end condition is satisfied, the output unit 106 outputs the data representing each of the basic matrices Hᵢ, and the data representing each of the weighting matrices Uᵢ. Note that the output unit 106 can output these data to any output destination. The output unit 106 may, for example, output (store) the data to the auxiliary storage device 208 illustrated in FIG. 3, may output (transmit) the data to a predetermined server device or the like via a communication network, or may output (store) the data to the recording medium 203 illustrated in FIG. 3.

<Hardware Configuration>

Next, a hardware configuration of the analyzing device 10 according to the present embodiment will be described with reference to FIG. 3. FIG. 3 is a diagram illustrating an example of the hardware configuration of the analyzing device 10 according to the present embodiment.

As illustrated in FIG. 3, the analyzing device 10 according to the present embodiment has an input device 201, a display device 202, an external I/F 203, RAM (Random Access Memory) 204, ROM (Read Only Memory) 205, a processor 206, a communication I/F 207, and the auxiliary storage device 208, as hardware. These hardware are communicably connected to each other via a bus B.

The input device 201 is, for example, a keyboard, a mouse, a touch panel, or the like. The display device 202 is, for example, a display or the like. Note that an arrangement may be made in which the analyzing device 10 does not have at least one of the input device 201 and the display device 202.

The external I/F 203 is an interface as to an external device. Examples of the external device include a recording medium 203a such as a CD, a DVD, an SD memory card, a USB memory card, and the like. The analyzing device 10 can perform reading from and writing to the recording medium 203a and so forth, via the external I/F 203. Note that one or more programs or the like that realize each function unit that the analyzing device 10 has (the input unit 101, the initializing unit 102, the separating unit 103, the updating unit 104, the determining unit 105 and the output unit 106) may be recorded in the recording medium 203a.

The RAM 204 is volatile semiconductor memory that temporarily stores the programs or the data. The ROM 205 is nonvolatile semiconductor memory that can store the programs or the data even after electrical power is turned off.

The processor 206 is various types of computing devices, such as a CPU (Central Processing Unit), a GPU (Graphics Processing Unit), and so forth, for example. Each function unit which the analyzing device 10 has can be realized by processing in which the processor 206 executes one or more programs stored in the auxiliary storage device 208 or the like, for example.

The communication I/F 207 is an interface for the analyzing device 10 to connect to the communication network. The one or more programs that realize each function unit which the analyzing device 10 has may be obtained (downloaded) from a predetermined server device or the like, via the communication I/F 207, for example.

The auxiliary storage device 208 is, for example, an HDD (Hard Disk Drive), an SSD (Solid State Drive), or the like. The program and the data stored in the auxiliary storage device 208 are, for example, an OS (Operating System), an application program that realizes various types of functions that run on the OS, one or more programs that realize each function unit the analyzing device 10 has, and the like.

The analyzing device 10 according to the present embodiment can realize various types of processes in the later-described “flow of non-negative matrix factorization” according to the present embodiment, by having the hardware configuration illustrated in FIG. 3. Note that although a case where the analyzing device 10 according to the present embodiment is realized as one device (computer) is illustrated in FIG. 3, this is not limiting. The analyzing device 10 according to the present embodiment may be realized by a plurality of devices (computers). Also, one device (computer) may have a plurality of processors 206 and a plurality of memory (RAM 204, ROM 205, auxiliary storage device 208, and so forth).

### Flow of Non-Negative Matrix Factorization According to Present Embodiment

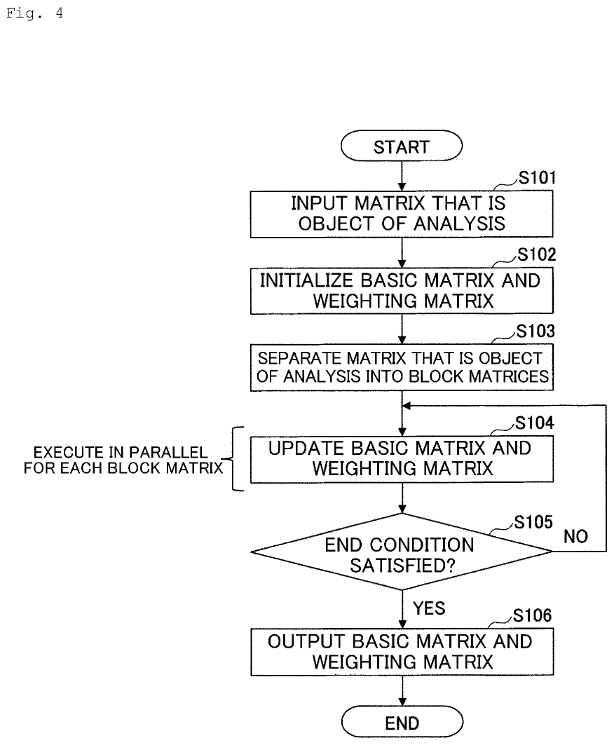

Hereinafter, the flow of non-negative matrix factorization which the analyzing device 10 according to the present embodiment executes will be described with reference to FIG. 4. FIG. 4 is a flowchart showing an example of the flow of the non-negative matrix factorization according to the present embodiment.

First, the input unit 101 inputs data representing the non-negative matrix Y to the separating unit 103 (step S101).

Next, the initializing unit 102 sets the initial values of the basic matrix Hᵢ and weighting matrix Wᵢ(i=1, 2, . . . , I) (to be more accurate, the initial values of data representing the basic matrix Hᵢ and the weighting matrix Wᵢ) (step S102). Note that I is an integer no less than 2, which is set in advance.

Next, the separating unit 103 separates the block matrix Y represented by the data input in the above step S101 into a plurality of block matrices Y₁, Y₂, . . . , Y_{I} (to be more accurate, separates the data representing the matrix Y into data representing each of the plurality of block matrices Yᵢ, Y₂, Y₁) (step S103). Each of the data representing these plurality of block matrices Y₁, Y₂, . . . , Y_{I} is each allocated to memory space of different child processes by the separating unit 103.

The following processes of step S104 and step S105 are executed in parallel for each child process (that is to say, are executed as a multi-process by the processor 206). Hereinafter, a case of executing processing of step S104 and step S105 for a certain block matrix Yᵢ will be described. Note that the number of child processes executable in parallel differs depending on the capabilities and so forth of the processor 206, and not necessarily all of the block matrices Yᵢ need to be executed in parallel.

The updating unit 104 updates each entry of the basic matrix Hᵢ and the weighting matrix Uᵢ regarding the above Expression (4) or Expression (6) on the basis of data representing the block matrix Yᵢ and the distance function Dc of the given graph G (step S104). Note that as described above, in the present embodiment, the graph G corresponding to the characteristics of the data analyzed using NMF is given to the analyzing device 10 in advance. However, such a graph G may be input by the input unit 101 in the above step S101.

Next, the determining unit 105 determines whether the predetermined end condition is satisfied (step S105). In a case where determination is made that the predetermined end condition is not satisfied in this step S105, the flow of the non-negative matrix factorization returns to step S104. Thus, the basic matrix Hᵢ and the weighting matrix Uᵢ are repetitively updated until the end condition is satisfied. Conversely, in a case where determination is made that the predetermined end condition is satisfied in step S105, the flow of the non-negative matrix factorization advances to step S106.

Finally, the output unit 106 outputs the data representing each of the basic matrix Hᵢ and data representing each of the weighting matrix Uᵢ(step S106).

As described above, the analyzing device 10 according to the present embodiment is able to realize high-speed NMF by separating the matrix Y into a plurality of block matrices Y₁, Y₂, . . . , Y_{I}, and by executing NMF on these block matrices Y₁, Y₂, . . . , Y_{I} in parallel. Also, by introducing the distance function Dc on the basis of the graph configuration of graph G for the object function of the NMF at this time, the predetermined basic matrices can be made to be basic matrices similar to each other. As a result, results similar to the conventional NMF can be obtained at higher speeds. That is to say, the NMF according to the present embodiment can obtain results similar to the conventional NMF. Thus, particularly in cases where a large-scale matrix Y with many rows and columns is the object, the NMF according to the present embodiment can obtain results in a shorter calculation time than the conventional NMF, and efficient analysis can be performed.

<Comparison with Conventional NMF>

The results of comparison regarding the conventional NMF using the above Expression (2) for updating the basic matrix and the weighting matrix (hereinafter also referred to as “conventional technique”), and the NMF according to the present embodiment using the above Expression (4) for updating the basic matrix and the weighting matrix (hereinafter also referred to as “technique according to the present embodiment”), will be described. Note that, regarding the conventional technique, in a case in which a non-negative matrix Y is input, update of the basic matrix and the weighting matrix is sequentially executed by one processor regarding the matrix Y, and regarding the technique according to the present embodiment, the matrix Y is separated into a plurality of block matrices Y₁, Y₂, . . . , Y_{I}, and thereafter, update of each of the basic matrix and the weighting matrix of these block matrices Y₁, Y₂, . . . , Y_{I} is executed as a multi-process using one processor.

(Data Used for Comparison)

Comparison of the conventional technique and the technique according to the present embodiment was performed using two types of matrix data below, in which the sizes thereof were different (matrix data 1 and matrix data 2), using data regarding the count of taxi rides in New York City as the matrix Y.

Matrix data1: Yₛₘₐₗₗ(24×2190)

Matrix data 1 is data where the counts of taxi rides in New York City are aggregated for each of the 6 districts of New York City. Matrix Yₛₘₐₗₗ=(y_{n,m}) represents the count of taxi rides from n o'clock to n+1 o'clock on day m (mod 6) regarding a district No.

$$⌈ \frac{m}{6} ⌉ \qquad [ Math . 17 ]$$

(i.e., the ceiling function value of m/6). Also, the matrix Yₛₘₐₗₗ was separated with respect to columns, yielding a plurality of block matrices is Yₛₘₐₗₗ*={Y₁, Y₂, . . . , Y₆}. The size of each block matrix Yᵢ(i=1, 2, . . . , 6) is 24×365, and

Yᵢ=(y_{n,m}⁽ⁱ⁾) [Math. 18]

represents the count of taxi rides from n o'clock to n+1 o'clock on day m within the district No. i. Note that the correlative relations between the district Nos. and the actual districts within New York City are as follows. District No. 1 is “Bronx”, district No. 2 is “Brooklyn”, district No. 3 is “EWR”, district No. 4 is “Manhattan”, district No. 5 is “Queens”, and district No. 6 is “Staten Island”.

Matrix data2,Y_{large}(144×85410)

Matrix data 2 is data where the counts of taxi rides in New York City are aggregated for each of the 234 districts of New York City. The aggregation was performed for each of the 6 districts in the matrix data 1, however, the breakdown of districts is much finer in the matrix data 2. Matrix Y_{large}=(y_{n,m}) represents the count of taxi rides from the 10n′th minute to the 10 (n+1′th) minute on the m (mod 234)′th day, regarding the district No.

$$⌈ \frac{m}{234} ⌉ \qquad [ Math . 19 ]$$

The plurality of block matrices is created by separating in two different ways regarding the matrix Y_{large}. In the first separation, the plurality of block matrices is Y_{large}*={Y₁, Y₂, . . . , Y₂₃₄}, and the sizes of each of the block matrices Yᵢ (i=1, 2, . . . , 234) are 144×365, and

Yᵢ=(Y_{n,m}^{I}) [Math. 20]

represents the count of taxi rides from the 10n′th minute to the 10 (n+1′th) minute on day m within the district No. i. Note that the district No. is 1 ≥i≥234.

In the second separation, the plurality of block matrices is Y_{large}**={Y₁, Y₂, . . . , Y₆}. The sizes of each of the block matrices Yᵢ (i=1, 2, . . . , 6) are different, where Y₁ is 144×15695, Y₂ is 144×22265, Y₃ is 144×365, Y₄ is 144×25550, Y₅ is 144×25185 and Y₆ is 144×7300, and

Yᵢ=(y_{n,m}⁽ⁱ⁾) [Math. 21]

represents the count of taxi rides from the 10n′th minute to the 10 (n+1)′th minute on day m within the district No. i. Note that, in the same way as the matrix data 1, the district No. is 1 ≥i≥6, and the correlative relations with the actual districts are the same as the matrix data 1.

(Construction of Graph G)

The graph G is constructed so that the vertices correspond to the district Nos. within New York City. Also, the vertices corresponding to the districts actually adjacent to each other are connected by edges. This is because it is conceivable that “there is a tendency (a common potential characteristic) for the count of taxi rides to be similar among districts that are close to each other”. Therefore, in the technique according to the present embodiment, the basic matrices corresponding to the districts adjacent to each other are matrices similar to each other. Note that such a graph G (or the graph structure of the graph G) is created or constructed in advance according to the characteristics of the data representing the non-negative matrix (in this case, the matrix data representing the count of taxi rides within New York City), and is given to the analyzing device 10.

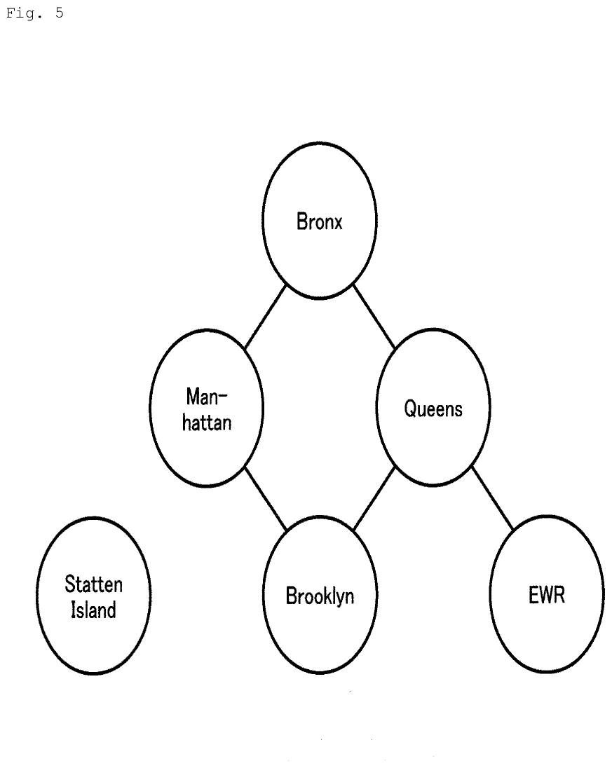

Accordingly, in a case of applying the technique according to the present embodiment to a plurality of block matrices Yₛₘₐₗₗ*or Y_{large}**, a graph G is constructed that has vertices corresponding to the six districts, and the vertices corresponding to districts that are actually adjacent are connected to each other by edges. This graph G is illustrated in FIG. 5. The graph G illustrated in FIG. 5 has vertices corresponding to each of the district Nos. 1 through 6, with the vertices corresponding to districts that are adjacent to each other being connected to each other by edges.

Here, the adjacency matrix A(G) of graph G illustrated in FIG. 5 is as in Expression (8) below.

$$\begin{matrix}[ Math . 22 ] & \\ A ( G ) = ( \begin{matrix}0 & 0 & 0 & 1 & 1 & 0 \\ 0 & 0 & 0 & 1 & 1 & 0 \\ 0 & 0 & 0 & 0 & 1 & 0 \\ 1 & 1 & 0 & 0 & 0 & 0 \\ 1 & 1 & 1 & 0 & 0 & 0 \\ 0 & 0 & 0 & 0 & 0 & 0\end{matrix} ) & ( 8 )\end{matrix}$$

Conversely, in the case of applying the technique according to the present embodiment to the plurality of block matrices Y_{large}*, finding the relations of adjacency regarding the 234 districts was difficult, and accordingly the graph G was constructed by the following Expression (9) and Expression (10) so as all of the vertices have three non-directed edges.

[Math. 23]

G(V={1,2, . . . ,I},E) (9)

E={(i,j)|i≡j(mod 4),i,j∈V} (10)

Note that the plurality of block matrices Y_{large}*is used only for evaluating the calculation time, and accordingly construction of such a graph G conceivably will pose no problem, which will be described later.

(Evaluation of Basic Matrix)

Evaluation of basic matrices was performed using the matrix data 1. First, the basic matrix was visualized using a heat map, and comparison was made among a case of applying the conventional technique to Yₛₘₐₗₗ, a case of applying the conventional technique to Yₛₘₐₗₗ*and a case of applying the technique according to the present embodiment to Yₛₘₐₗₗ*. Next, the evaluated value was obtained by Expression (11) below, and comparison was made between the case where the conventional technique was applied to Yₛₘₐₗₗ*and the case where the technique according to the present embodiment was applied to Yₛₘₐₗₗ*.

$$\begin{matrix}[ Math . 24 ] & \\ D = {\sum }_{( i , j ) ∈ E} {\sum }_{( n , k )} {\vert {H}_{i , n , k} - {H}_{j , n , k} \vert}^{2} & ( 11 )\end{matrix}$$

Here, it can be said that the smaller the value of an evaluation value D becomes, the better the data of the mutually-adjacent districts in the similar feature space is expressed. Note that a set E of the graph G correlating to the adjacency matrix A (G) in the above Expression (8) was used as the set E of the edges.

Also, as a more specific condition, an arrangement was made where the number of features was set to K=5, the end condition 1 was used for the end condition of the determining unit 105, and the updating unit 104 ends updating in a case in which the count of repetition reaches 104 times. Furthermore, for initializing the basic matrix Hᵢ and the weighting matrix Uᵢ, a uniform random number was used where the range is

$$[ 0.0 , \sqrt{\frac{4.0 {\sum }_{n , m} {Y}_{i , n , m}}{6 \dot{2} 4 \dot{3} 65}} ] . \qquad [ Math . 25 ]$$

By using this random number, the expectation value of the initial value satisfies

$$E [ {[ {\hat{Y}}_{i} ]}_{n , m} ] = \frac{{\sum }_{( n , m )} {Y}_{i , n , m}}{n m} . \qquad [ Math . 26 ]$$

In addition, in the execution of a multi-process of the technique according to the present embodiment, synchronization is performed every time the repetition count is 100, and accordingly the update counts of each of Hᵢ and Uᵢ do not differ by 100 or more. Furthermore, the hyperparameter a was set to α=500.

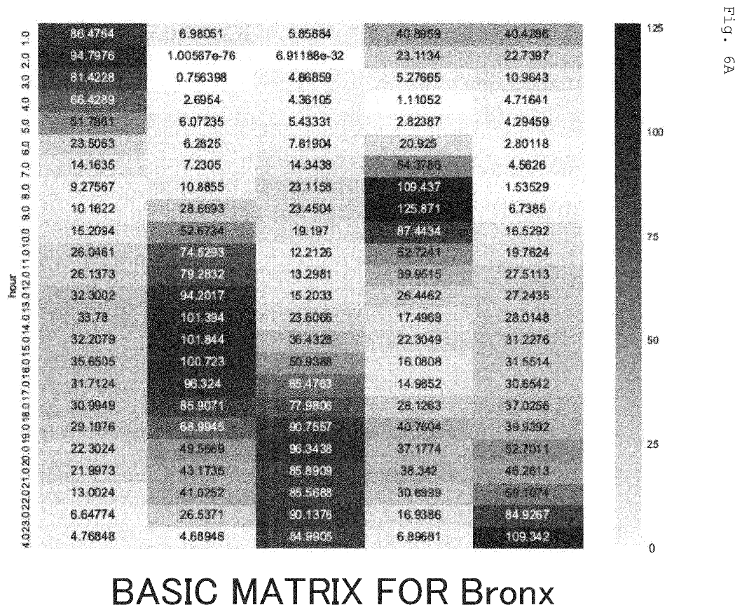

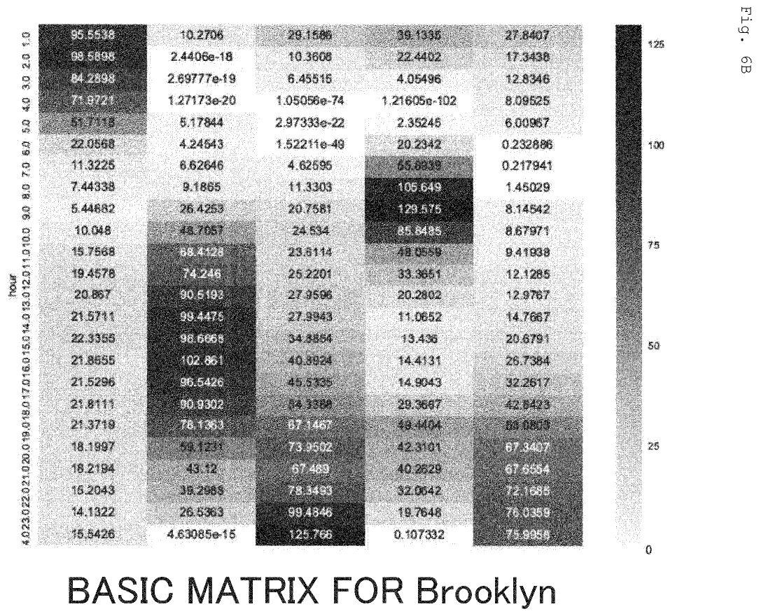

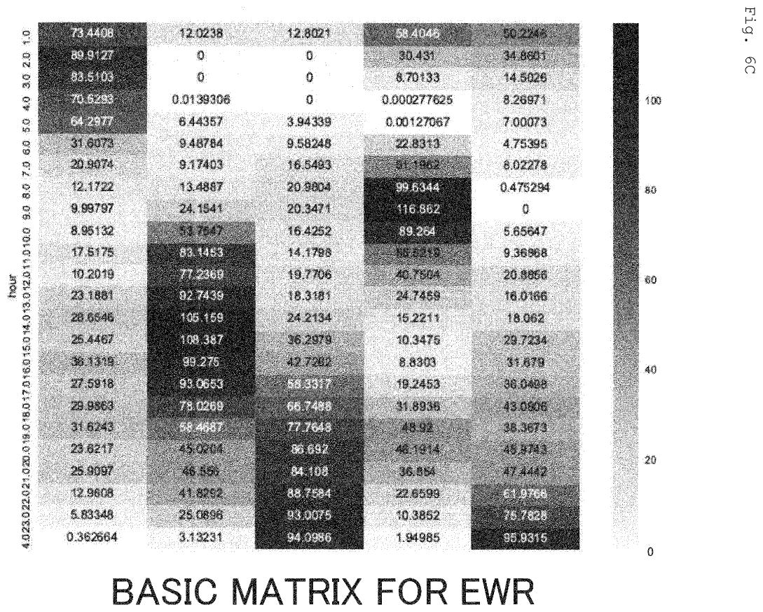

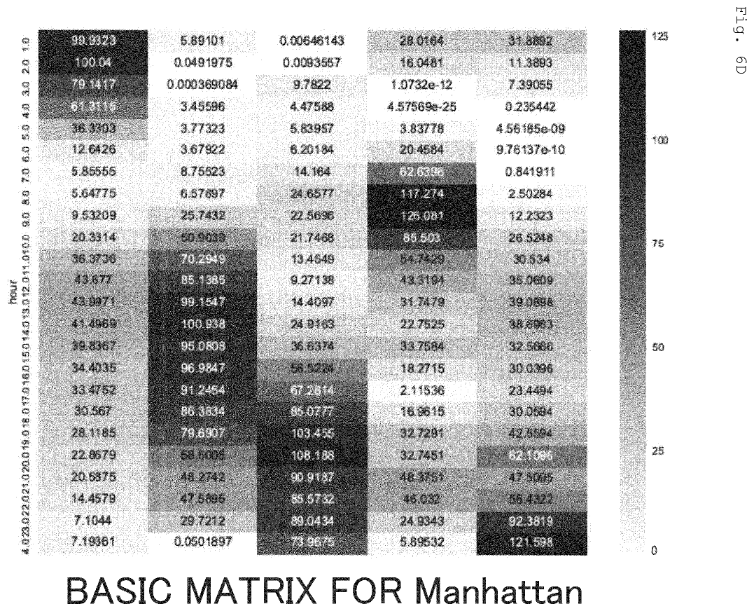

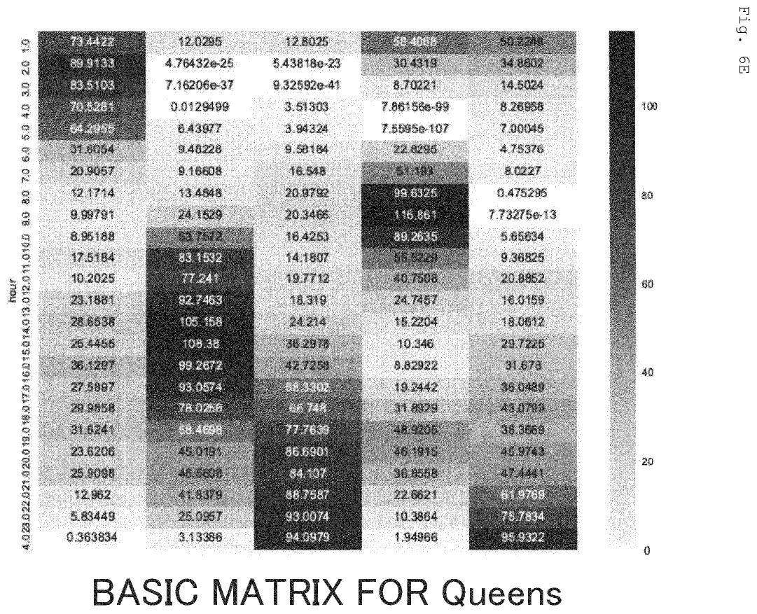

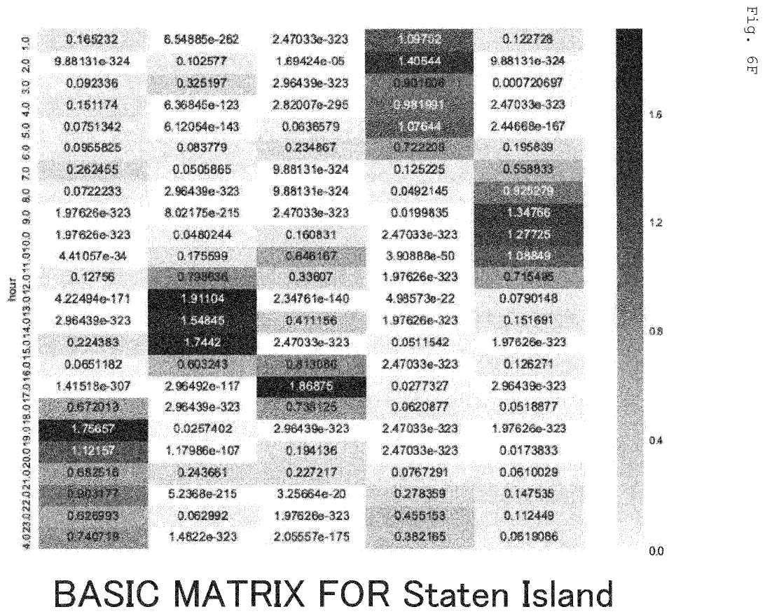

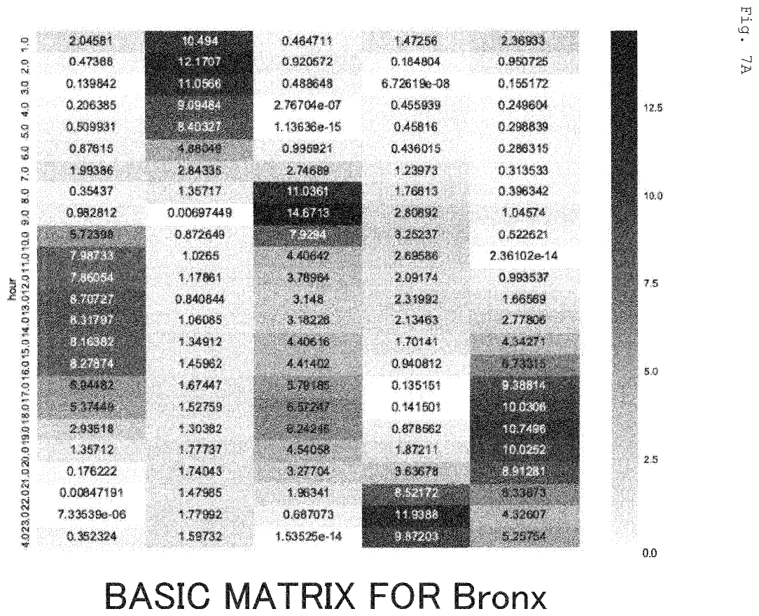

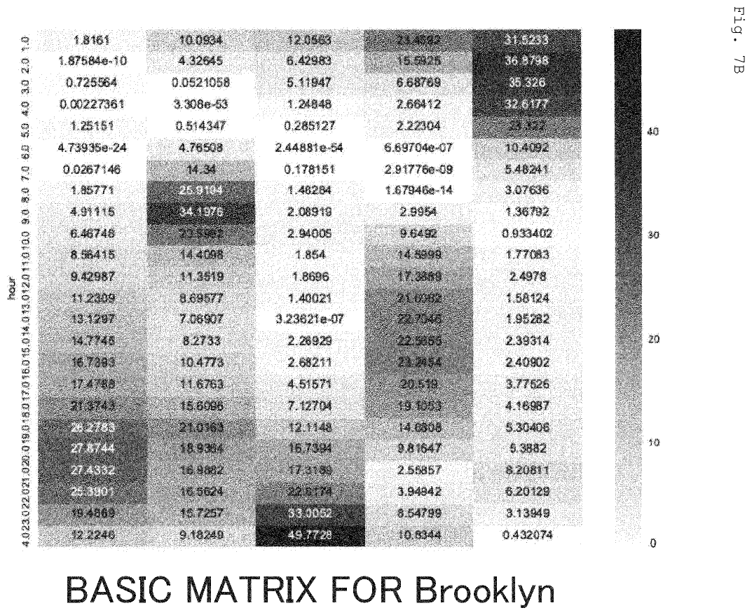

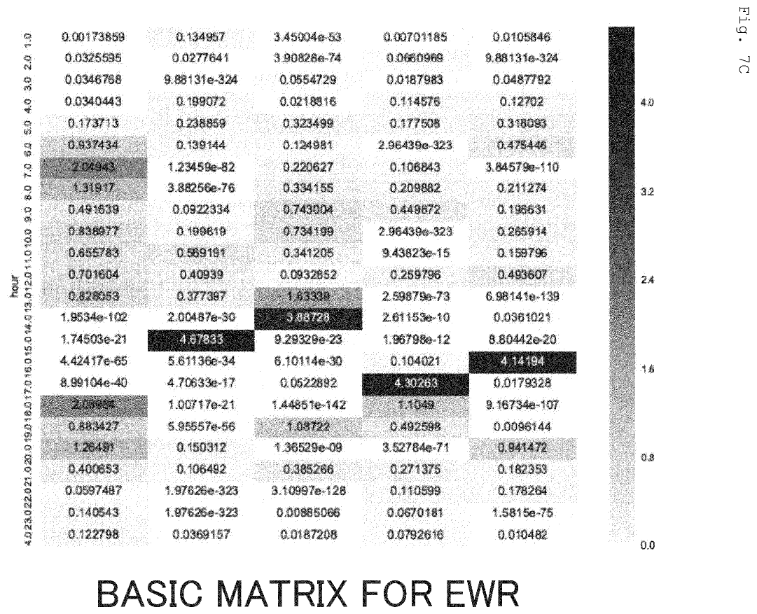

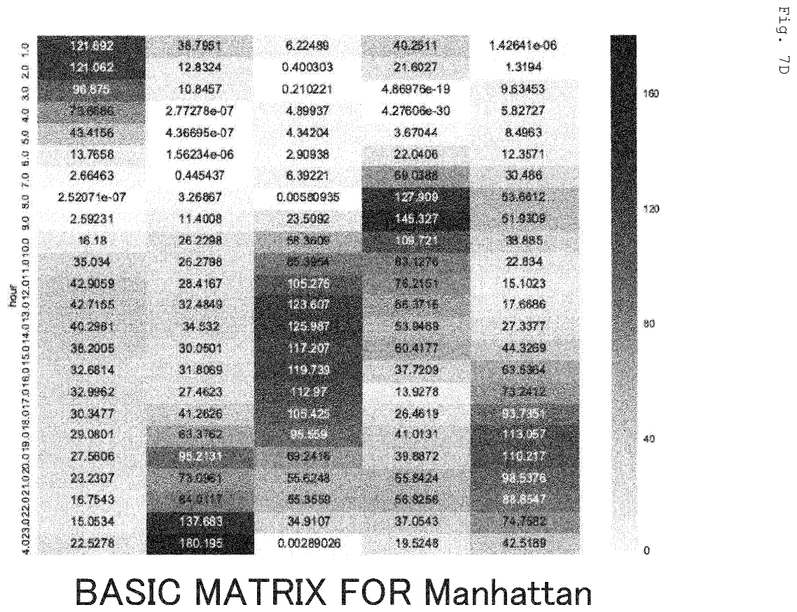

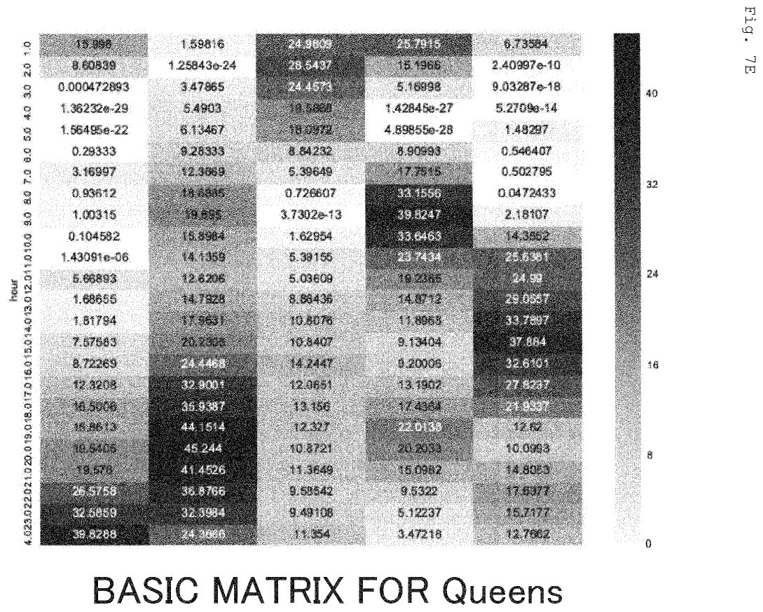

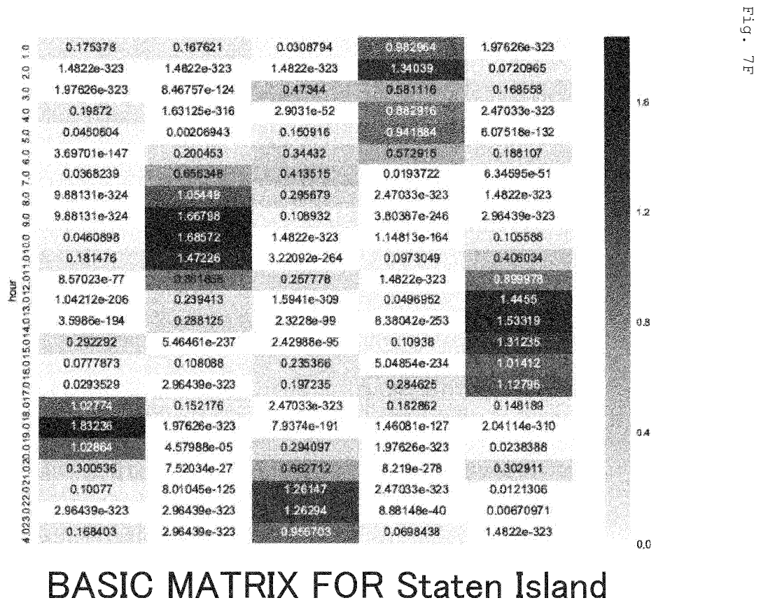

Under the above conditions, the case where the conventional technique is applied to the plurality of block matrices Yₛₘₐₗₗ*, and the case where the technique according to the present embodiment is applied to the plurality of block matrices Yₛₘₐₗₗ*, will be described first. FIG. 6A through FIG. 6F are heat maps of the basic matrix Hᵢ each corresponding to each district regarding the case where the technique of the present embodiment is applied to Yₛₘₐₗₗ*. Conversely, FIG. 7A through FIG. 7F are heat maps of the basic matrix Hᵢ each corresponding to each district regarding the case where the conventional technique is applied to Yₛₘₐₗₗ*.

It can be understood by comparing FIG. 6A through FIG. 6F and FIG. 7A through FIG. 7F that, while the basic matrix differs at all districts in the conventional technique, it can be seen that the basic matrices in Bronx, Brooklyn, EWR, Manhattan and Queens are similar matrices in the technique according to the present embodiment. That is to say, in the technique according to the present embodiment, the distances among the basic matrices corresponding to the connected vertices of the graph G were successfully made small.

Also, the evaluation values D of the case where the conventional technique was applied to the plurality of block matrices Yₛₘₐₗₗ*and the case where the technique according to the present embodiment was applied to the plurality of block matrices Yₛₘₐₗₗ*are shown below in Table 1.

TABLE 1

| | Conventional technique | Proposed technique |
|---|---|---|
| D | 1.6 × 10⁶ | 1.8 × 10⁵ |

Note that the evaluation value D in the above Table 1 is the mean value of the evaluation values D obtained ten times using the above Expression (11).

As shown in the above Table 1, the value of the evaluation value D of the technique according to the present embodiment is smaller in the case where comparison is made between the conventional technique and the technique according to the present embodiment, and the distance between the predetermined basic matrices can be made to be smaller.

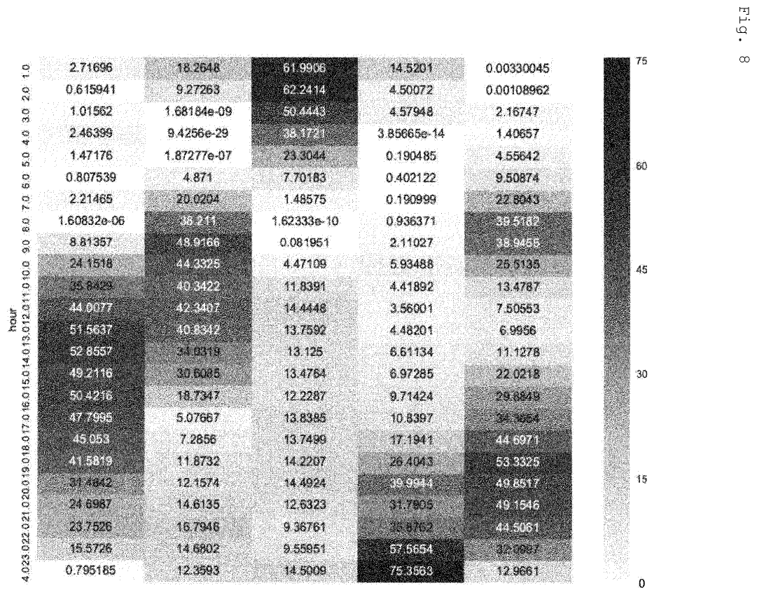

Next, description will be made regarding the case where the conventional technique is applied to the matrix Yₛₘₐₗₗ, and the case where the technique according to the present embodiment is applied to the plurality of block matrices Yₛₘₐₗₗ*. FIG. 8 is a heat map of the basic matrix regarding the case where the conventional technique is applied to the matrix Yₛₘₐₗₗ.

By comparing FIG. 6A through FIG. 6F and FIG. 8, each of the basic matrices respectively shown in FIG. 6A through FIG. 6E (that is to say, the basic matrix corresponding to Bronx, the basic matrix corresponding to Brooklyn, the basic matrix corresponding to EWR, the basic matrix corresponding to Manhattan, and the basic matrix corresponding to Queens) are matrices that are also similar to the basic matrix shown in FIG. 8 where the column vectors are randomly interchanged. Therefore, it can be said that equivalent results are obtained regarding the case where the conventional technique is applied to Yₛₘₐₗₗ and the case where the technique according to the present embodiment is applied to a plurality of block matrices Yₛₘₐₗₗ*.

Note that in the case where the technique according to the present embodiment is applied to a plurality of block matrices Yₛₘₐₗₗ*, the basic matrix corresponding to the district that does not have any connected components with other districts within the graph G (Staten Island) is a matrix entirely different from other districts. Therefore, block matrices expressed with a common basic matrix using the graph G can be selected in the technique according to the present embodiment. Thus, using the technique according to the present embodiment enables more flexible analysis to be performed as compared to the conventional technique.

(Evaluation of Calculation Time)

Evaluation of the calculation time was performed using the matrix data 2. Comparison for the evaluation of the calculation time was performed among the case where the conventional technique was applied to Y_{large}, the case where the technique according to the present embodiment was applied to Y_{large}*, and the case where the technique according to the present embodiment was applied to Y_{large}**.

As for detailed conditions, an arrangement was made where the number of features was K=5, the end condition 1 was used for the end condition of the determining unit 105, and the updating unit 104 ends updating in a case in which the count of repetition reaches 10³ times. Furthermore, as for the initialization for the basic matrix Hᵢ and the weighting matrix Uᵢ, a uniform random number where the range is

$$[ 0. , \sqrt{\frac{4. {\sum }_{n , m} {Y}_{i , n , m}}{6 \dot{2} 4 \dot{3} 65}} ] \qquad [ Math . 27 ]$$

was used. By using this random number, the expectation value of the initial value satisfies

$$E [ {[ {H}_{i} {U}_{i} ]}_{n , m} ] = \frac{{\sum }_{( n , m )} {Y}_{i , n , m}}{n m} . \qquad [ Math . 28 ]$$

In addition, in execution of a multi-process of the technique according to the present embodiment, synchronization is performed every time the repetition count is 100, so that the update counts of each of Hᵢ and Uᵢ do not differ by 100 or more. Furthermore, the hyperparameter a was set to α=500.

Here, the calculation time of the case regarding the conventional technique was applied to Y_{large}, the case where the technique according to the present embodiment was applied to Y_{large}*and the case where the technique according to the present embodiment was applied to Y_{large}**are shown below in Table 2.

TABLE 2

| | Technique | Technique | |
|---|---|---|---|
| | according to | according to | |
| | present | present | Conventional |
| | embodiment | embodiment | technique |
| | (applied to | (applied to | (applied to |
| | Y_{large}**) | Y_{large}*) | Y_{large}) |
| Calculation time | 13.248 | 7.49 | 72.6 |
| (seconds) | | | |

As shown in the above Table 2, it can be understood that the calculation times regarding the cases where the technique according to the present embodiment was applied to Y_{large}*and Y_{large}**are shorter than the calculation time regarding the case where the conventional technique was applied to Y_{large}.

Furthermore, it can be understood that the calculation time was shorter regarding the case where the technique according to the present embodiment was applied to 234 block matrices Y_{large}*, as compared to the case where the technique according to the present embodiment was applied to 6 block matrices Y_{large}**. This is because the number of executable processes in parallel by the processor used in this comparison was 112.

<Efficient Parallelization>

Here, in the technique according to the present embodiment, in a case where the edge between the vertices i, j does not exist within the given graph G, the update of the basic matrix Hᵢ and Hⱼ can be performed in parallel asynchronously. Here, a vertex set V={1, 2, . . . , I} of the graph G is separated into groups, and a separation of a partial vertex set {V₁, V₂, . . . , Vₚ} (where p=1, 2, . . . , P and each V_{P} is a vertex set where an edge does not exist between any two vertices included in this V_{P}) is found. By using the above partial vertex set that is found, the basic matrices can be updated more efficiently. That is to say, the update of the basic matrix corresponding to the vertices included in each partial vertex set Vₚ here can be performed as an asynchronous parallelized update. Therefore, the overhead due to the synchronization of the update count can be reduced, and more efficient update of the basic matrix can be performed.

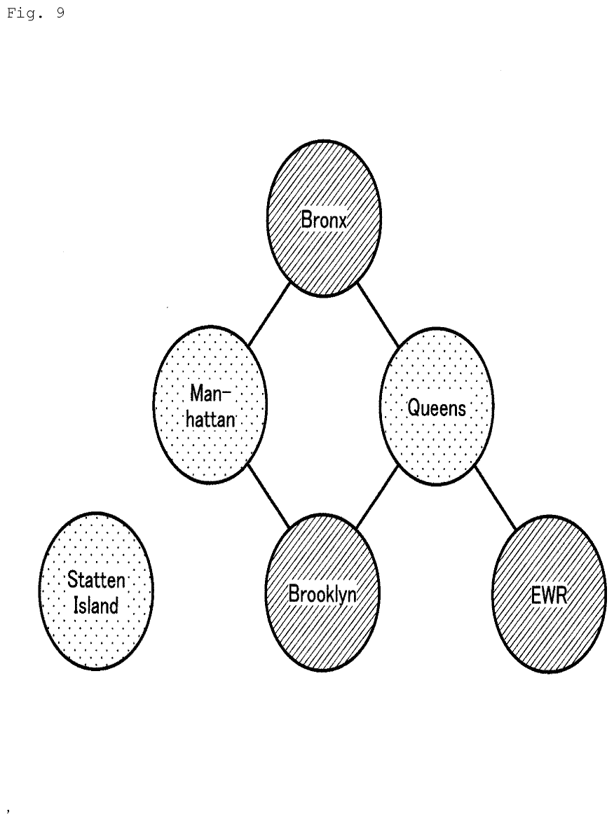

Moreover, by minimizing the number of separations P into the partial vertex sets, the number in parallel can be increased. The problem of minimizing the number of separations P is a graph vertex coloring problem, and the problem of finding the minimal chromatic number is a problem of an NP-hard class. Here, the chromatic number (that is to say, the number of separations P) is found heuristically. An example of a technique to obtain the chromatic number heuristically is the Welsh-Powell algorithm (e.g., see Reference 3). A case where the chromatic number of graph G shown in FIG. 6 was obtained and each of the vertices were colored using this Welsh-Powell algorithm is illustrated in FIG. 9. The example illustrated in FIG. 9 is a case in which the chromatic number is P=2.

[Reference 3] Welsh, D. J. A.; Powell, M. B., “An upper bound for the chromatic number of a graph and its application to timetabling problems”, The Computer Journal 10 (1): 85-86, 1967.

Note that the above separation into the partial vertex sets may be performed by the initializing unit 102 or the separating unit 103, for example, or may be performed by another functional unit different from these functional units. Also, the timing of executing the processing for separation into the partial vertex sets may be any timing, as long as executed prior to step S104 in FIG. 4.

The present invention is not limited to the specifically disclosed embodiments described above, and various types of modifications and alterations may be made without departing from the scope of the claims.

### REFERENCE SIGNS LIST

10 Analyzing device
101 Input unit
102 Initializing unit
103 Separating unit
104 Updating unit
105 Determining unit
106 Output unit

1. An analyzing device comprising circuitry configured to execute a method comprising:
receiving matrix data representing a non-negative matrix Y as input;
separating the matrix Y into a plurality of block matrices Yᵢ (i=1, . . . , I) configured of one column or two or more columns of the matrix Y; and
repeatedly updating a matrix Hᵢ and a matrix Uᵢ so that a product of the matrix Hᵢ and the matrix Uᵢ becomes close to the block matrices Yᵢ, in parallel, with regard to at least two or more of the block matrices Yᵢ,
wherein
the repeated updating executes in parallel, on the basis of a graph structure given in advance in accordance with the matrix Y, so that the distance between predetermined matrices Hᵢ and Hⱼ (j≠i, j ∈{1, . . . , I}) becomes closer.

2. The analyzing device according to claim 1,
wherein the graph structure has a structure representing a graph in which a vertex set is V={1, . . . , I}, and a set of edges connecting predetermined vertices to each other is E,
and wherein the updating includes
executing the repeated updating processing in parallel, so that the distance between the matrices Hᵢ and Hⱼ corresponding to vertices i and j connected by the edge becomes closer.

3. The analyzing device according to claim 2, wherein the updating includes
synchronizing a count of updates of the matrices Hᵢ and Uᵢ regarding which the repeated updating in parallel is executed, each time the repeated updating reaches a predetermined repetition count.

4. The analyzing device according to claim 3, the circuitry further configured to execute the method comprising:
separating the vertex set into partial vertex sets configured of vertices of which two arbitrary vertices are not connected by an edge,
wherein the updating includes
not synchronizing a count of updates of matrices Hᵢ and Uᵢ, and matrices Hⱼ and Uⱼ, respectively corresponding to the vertex i and the vertex j included in a same partial vertex set.

5. The analyzing device according to claim 1, the circuitry further configured to execute the method comprising:
determining whether or not predetermined end conditions are satisfied,
wherein the updating includes
executing the repeated updating in parallel until determination is made by the determining means that the end conditions are satisfied.

6. The analyzing device according to claim 1,
wherein the distance is a Frobenius norm or normalized KL divergence.

7. An analyzing method, comprising:
receiving matrix data representing a non-negative matrix Y as input;
separating the matrix Y into a plurality of block matrices Yᵢ (i=1, . . . , I) configured of one column or two or more columns; and
repeatedly updating processing of a matrix Hᵢ and a matrix Uᵢ so that a product of the matrix Hᵢ and the matrix Uᵢ becomes close to the block matrices Yᵢ, in parallel, with regard to at least two or more of the block matrices Yᵢ,
wherein,
the repeated updating executes in parallel, on the basis of a graph structure given in advance in accordance with the matrix Y, so that the distance between predetermined matrices Hᵢ and Hⱼ (j≠i, j ∈ {1, . . . , I}) becomes closer.

8. A computer-readable non-transitory recording medium storing computer-executable program instructions that when executed by a processor cause a computer system to execute a method comprising:
receiving matrix data representing a non-negative matrix Y as input;
separating the matrix Y into a plurality of block matrices Y, (i=1, . . . ,I) configured of one column or two or more columns of the matrix Yᵢ; and
repeatedly updating a matrix Hᵢ and a matrix Uᵢ so that a product of the matrix Hᵢ and the matrix Uᵢ becomes close to the block matrices Yᵢ, in parallel, with regard to at least two or more of the block matrices Yᵢ,
wherein
the repeated updating executes in parallel, on the basis of a graph structure given in advance in accordance with the matrix Y, so that the distance between predetermined matrices Hᵢ and Hⱼ (j≠i, j ∈{1, . . . , I}) becomes closer.

9. The analyzing device according to claim 4, the circuitry further configured to execute the method comprising:
determining whether or not predetermined end conditions are satisfied,
wherein the updating includes
executing the repeated updating in parallel until determination is made by the determining means that the end conditions are satisfied.

10. The analyzing method according to claim 7,
wherein the graph structure has a structure representing a graph in which a vertex set is V={1, . . . , I}, and a set of edges connecting predetermined vertices to each other is E,
and wherein the updating includes
executing the repeated updating processing in parallel, so that the distance between the matrices Hᵢ and Hⱼ corresponding to vertices i and j connected by the edge becomes closer.

11. The analyzing method according to claim 7, the method further comprising:
determining whether or not predetermined end conditions are satisfied,
wherein the updating includes:
executing the repeated updating in parallel until determination is made by the determining means that the end conditions are satisfied.

12. The analyzing method according to claim 7, wherein the distance is a Frobenius norm or normalized KL divergence.

13. The computer-readable non-transitory recording medium according to claim 8,
wherein the graph structure has a structure representing a graph in which a vertex set is V={1, . . . , I}, and a set of edges connecting predetermined vertices to each other is E,
and wherein the updating includes
executing the repeated updating processing in parallel, so that the distance between the matrices Hᵢ and Hⱼ corresponding to vertices i and j connected by the edge becomes closer.

14. The computer-readable non-transitory recording medium according to claim 8, the computer-executable program instructions when executed further causing the system to execute a method comprising:
determining whether or not predetermined end conditions are satisfied,
wherein the updating includes:
executing the repeated updating in parallel until determination is made by the determining means that the end conditions are satisfied.

15. The computer-readable non-transitory recording medium according to claim 8, wherein the distance is a Frobenius norm or normalized KL divergence.

16. The analyzing method according to claim 10, wherein the updating includes:
synchronizing a count of updates of the matrices Hᵢ and Uᵢ regarding which the repeated updating in parallel is executed, each time the repeated updating reaches a predetermined repetition count.

17. The analyzing method according to claim 16, the method further comprising:
separating the vertex set into partial vertex sets configured of vertices of which two arbitrary vertices are not connected by an edge,
wherein the updating includes not synchronizing a count of updates of matrices Hᵢ and Uᵢ, and matrices Hⱼ and Uⱼ, respectively corresponding to the vertex i and the vertex j included in a same partial vertex set.

18. The analyzing method according to claim 17, the method further comprising:
determining whether or not predetermined end conditions are satisfied,
wherein the updating includes
executing the repeated updating in parallel until determination is made by the determining means that the end conditions are satisfied.

19. The computer-readable non-transitory recording medium according to claim 13, wherein the updating includes:
synchronizing a count of updates of the matrices Hᵢ and Uᵢ regarding which the repeated updating in parallel is executed, each time the repeated updating reaches a predetermined repetition count.

20. The computer-readable non-transitory recording medium according to claim 19, the computer-executable program instructions when executed further causing the system to execute a method comprising:
determining whether or not predetermined end conditions are satisfied,
wherein the updating includes
executing the repeated updating in parallel until determination is made by the determining means that the end conditions are satisfied.
